(19) United States
(12) Patent Application Publication
(10) Pub. No.: US 2026/0340581 A1
(43) Pub. Date: Oct. 29, 2026

(54) ORDER ALLOCATION METHOD AND INFORMATION PROCESSING DEVICE

(71) Applicant: Panasonic Intellectual Property Management Co., Ltd., Osaka (JP)

(72) Inventors: Manano ASAMI, Kanagawa (JP); Masashi TAKEMURA, Kanagawa (JP)

(73) Assignee: Panasonic Intellectual Property Management Co., Ltd., Osaka (JP)

(21) Appl. No.: 19/538,205

(22) Filed: Feb. 12, 2026

(30) Foreign Application Priority Data
Apr. 25, 2025 (JP) 2025-073420

(51) Int. Cl. G06Q 10/087

(52) U.S. Cl. CPC G06Q 10/08741

(57) ABSTRACT

An order allocation method is the method for allocating an order related to picking work acquired from an external system to each work area for a person or a robot, and includes: an acquisition step of acquiring an emergency order from the external system; and an allocation step of allocating the emergency order to at least one of the work areas based on work information on an order already allocated to each of the work areas, emergency storage bin information on an emergency storage bin that is a storage bin of an article related to the emergency order, and specification information on a specification of the robot.

### BACKGROUND

### 1. Technical Field

The present disclosure relates to an order allocation method and an information processing device.

### 2. Description of the Related Art

Patent Literature 1 discloses an order processing method used in a distribution system having a plurality of stations for performing work of picking up an article from a shelf conveyed by an automatic conveyance device according to an order. This order processing method is configured to receive an emergency order, determine a station to which the emergency order is allocated based on the contents of the emergency order and the contents of the order allocated to each station, and cause the automatic conveyance device to arrange a shelf to be used in the emergency order in the station to which the emergency order is allocated.

### CITATION LIST

### PATENT LITERATURE

PTL 1: Unexamined Japanese Patent Publication No. 2024-175326

### SUMMARY

The present disclosure has been made in view of the above-described conventional situation, and an object of the present disclosure is to provide an order allocation method and an information processing device capable of allocating an emergency order to a more appropriate task assignee.

The present disclosure provides an order allocation method for allocating an order related to picking work acquired from an external system to each work area in which a person or a robot works, the order allocation method including: an acquisition step of acquiring an emergency order from the external system; and an allocation step of allocating the emergency order to at least one of the work areas based on work information on an order already allocated to each of the work areas, emergency storage bin information on an emergency storage bin that is a storage bin of an article related to the emergency order, and specification information on a specification of the robot.

The present disclosure provides an information processing device for allocating an order related to picking work acquired from an external system to each work area in which a person or a robot works, the information processing device including: a communication unit that acquires an emergency order from the external system; and a controller that allocates the emergency order to at least one of the work areas based on work information on the order already allocated to each of the work areas, emergency storage bin information on an emergency storage bin that is a storage bin of an article related to the emergency order, and specification information on a specification of the robot.

The present disclosure can allocate an emergency order to a more appropriate task assignee.

### BRIEF DESCRIPTION OF THE DRAWINGS

FIG. 1 is a block diagram illustrating an example of a system configuration according to the first exemplary embodiment;

FIG. 2 is a block diagram illustrating a configuration example of an information processing device that can be used in the system according to the first exemplary embodiment;

FIG. 3 is a schematic diagram illustrating a configuration example in a warehouse according to the first exemplary embodiment;

FIG. 4 is a schematic diagram illustrating an example of a work space in a warehouse according to the first exemplary embodiment;

FIG. 5 is a schematic diagram illustrating a first method of the emergency order allocation method according to the first exemplary embodiment;

FIG. 6 is a schematic diagram illustrating a second method of the emergency order allocation method according to the first exemplary embodiment;

FIG. 7 is a flowchart for explaining a flow of processing of emergency order allocation in the first method in the emergency order allocation method according to the first exemplary embodiment;

FIG. 8 is a flowchart for explaining a flow of the first urgency determination processing in the first method in the emergency order allocation method according to the first exemplary embodiment;

FIG. 9 is a flowchart for explaining a flow of the second urgency determination processing in the first method in the emergency order allocation method according to the first exemplary embodiment;

FIG. 10 is a flowchart for explaining a flow of recovery processing from an emergency order to a normal order in the first method in the emergency order allocation method according to the first exemplary embodiment;

FIG. 11 is a flowchart for explaining a flow of processing of emergency order allocation in the second method in the emergency order allocation method according to the first exemplary embodiment;

FIG. 12 is a flowchart for explaining a flow of work area selection processing (only a person is a task assignee) in the second method in the emergency order allocation method according to the first exemplary embodiment;

FIG. 13 is a flowchart for explaining a flow of work area selection processing (only a robot is a task assignee) in the second method in the emergency order allocation method according to the first exemplary embodiment;

FIG. 14 is a flowchart for explaining a flow of work area selection processing (both a person and a robot are task assignees) in the second method in the emergency order allocation method according to the first exemplary embodiment; and

FIG. 15 is a flowchart for explaining a flow of recovery processing from an emergency order to a normal order in the second method in the emergency order allocation method according to the first exemplary embodiment.

### DETAILED DESCRIPTIONS

### Background of present disclosure

As in the technique disclosed in Patent Literature 1, there is a conventional method in which, when an emergency order occurs, the normal order processing is interrupted or the emergency order is interposed in the normal order processing order to preferentially process the emergency order. However, in the conventional method, the emergency order is simply allocated to the person or the robot based on the contents of the emergency order and the contents of the normal order, and thus the insufficient performance (that is, the specification) of the robot may cause the robot to fail to respond to the allocated emergency order.

Therefore, in the following exemplary embodiment, an order allocation method and an information processing device capable of allocating an emergency order to a more appropriate task assignee will be described.

Hereinafter, each exemplary embodiment specifically disclosing an order allocation method and an information processing device according to the present disclosure will be described in detail with reference to the drawings as appropriate. It is noted that a more detailed description than needed may be omitted. For example, detailed descriptions of already well-known matters and duplicated descriptions of substantially the same configuration may be omitted. This is to avoid an unnecessarily redundant description below and to facilitate understanding of those skilled in the art. Note that the attached drawings and the following description are provided for those skilled in the art to fully understand the present disclosure, and are not intended to limit the subject matter as described in the appended claims.

### First exemplary embodiment

### System configuration

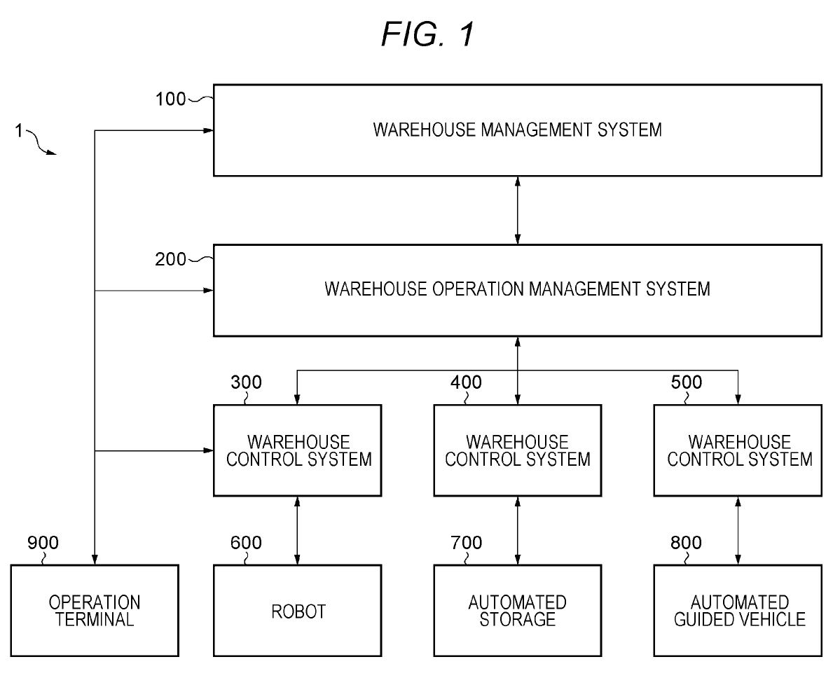

FIG. 1 is a block diagram illustrating an overall outline of warehouse system 1 according to the first exemplary embodiment. The system configuration illustrated in FIG. 1 is an example, and one system may be divided into a plurality of systems, or a plurality of systems may be collectively configured. One system or device illustrated in FIG. 1 may be provided as a plurality of systems or devices. Further, the processing entity described below is an example, and a part of a function of a certain system may be realized as a function of another system.

Warehouse system 1 includes warehouse management system 100, warehouse operation management system 200, warehouse control systems 300, 400, 500, robot 600, automated storage 700, automated guided vehicle 800, and operation terminal 900. The components constituting warehouse system 1 are configured to be able to communicate with each other via a network.

Warehouse management system 100 is a system that manages and controls distribution in the warehouse, and is positioned at the highest level in the configuration example illustrated in FIG. 1. Warehouse management system 100 manages, for example, stock management of objects in the warehouse, and entrance and exit (receiving and shipment) and movement of the objects. The warehouse management system may be referred to as WMS (Warehouse Management System) or the like. Warehouse management system 100 is configured to be able to communicate with a further external system (not illustrated in FIG. 1), and may acquire and manage instructions related to receipt and shipment of goods, product information, information on equipment in the warehouse such as a robot, information on a worker, and the like. In addition, warehouse management system 100 transmits a normal order or an emergency order to warehouse operation management system 200.

Warehouse operation management system 200 is a system that manages and controls work in the warehouse, and is positioned below warehouse management system 100 in the configuration example illustrated in FIG. 1. The warehouse operation management system may be referred to as warehouse execution system (WES) or the like. For example, warehouse operation management system 200 comprehensively controls work contents of various entities who perform work in the warehouse and equipment in the warehouse. In addition, warehouse operation management system 200 may manage the normal order and the emergency order acquired from warehouse management system 100, and for example, may manage them in units of batches.

Warehouse control systems 300, 400, 500 manage and control various types of equipment in the warehouse, respectively. A warehouse control system may be referred to as WCS, for example. In the configuration example illustrated in FIG. 1, warehouse control systems 300, 400, 500 are responsible for management and control of robot 600, automated storage 700, and automated guided vehicle 800, respectively. Robot 600 includes, for example, an orthogonal mechanism or a multi-axis arm, and is configured to be able to hold a product at a distal end portion thereof. The configuration of the distal end portion of robot 600 may be, for example, a suction type or a gripping type with a multi-finger hand, and is not particularly limited. A plurality of types of robots 600 may be installed in the warehouse on the assumption of picking work on various products. A camera for capturing a peripheral image, in particular, an image of a bin disposed in the periphery, may be installed around robot 600.

Automated storage 700 is configured to be capable of accommodating a plurality of bins, and conveys the bins using automated guided vehicle 800 in response to a request. The bin is not necessarily conveyed by automated guided vehicle 800. For example, the bin may be conveyed using a belt conveyor or the like. Automated storage 700 is configured by, for example, a frame on a grid so as to be able to accommodate a plurality of bins. The bins accommodated in automated storage 700 include a storage bin for storing a product. In addition, the storage bin may be an empty bin in which no products are placed, or a bin in which products to be accommodated have not yet been determined. The bins used in automated storage 700 also include a shipment bin for putting products together at the time of shipping. The storage bin and the shipment bin may have different shapes and dimensions, but are configured to be conveyable by automated guided vehicle 800, and in the description, the storage bin and the shipment bin are assumed to have the same configuration of a rectangular box.

Automated guided vehicle 800 is a vehicle for conveying a bin to a predetermined position, and automatically moves, stands by, and so on based on an instruction. Automated guided vehicle 800 may be configured such that a bin is detachably mounted on an upper portion thereof, or may be configured such that the bin is conveyed by being pushed or pulled. Automated guided vehicle 800 includes, for example, a traveling unit for performing an operation related to movement, a sensor for acquiring peripheral information, and a communication unit for transmitting and receiving data to and from warehouse control system 300.

Operation terminal 900 is an information processing device configured to be available to a worker inside and outside the warehouse. Operation terminal 900 may be, for example, an installation type information processing device such as a personal computer (PC), or may be a mobile terminal such as a tablet terminal, a POS terminal, a handy terminal, or a smartphone. Operation terminal 900 transmits and receives data to and from warehouse management system 100, warehouse operation management system 200, warehouse control systems 300, 400, 500, and the like, receives notifications from each of these systems, and is used for entering settings to and operating each of these systems.

### Hardware configuration example

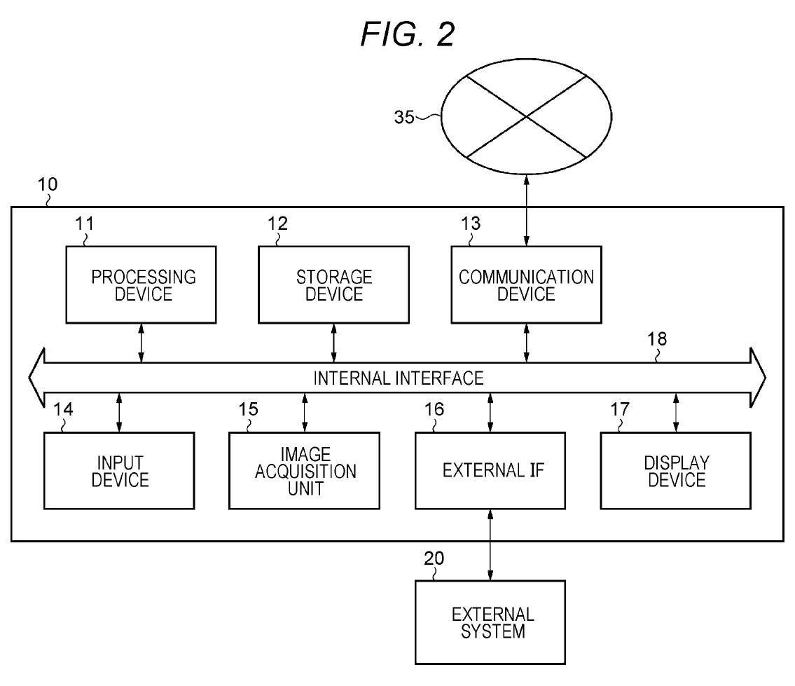

Each system illustrated in FIG. 1 may be configured as an on-premises server device at a base where the warehouse is provided, or may be configured as a cloud type on a network. FIG. 2 is a block diagram illustrating an example of a hardware configuration of an information processing device applicable as a device constituting each system according to the first exemplary embodiment. Here, the description will be given assuming that the configurations of the devices constituting the respective systems are the same, but some parts may be omitted, or other parts may be added according to the function to be provided. Examples of the part to be added include a barcode reader used to acquire information from a barcode attached to a product or a bin in the warehouse.

Information processing device 10 includes processing device 11, storage device 12, communication device 13, input device 14, image acquisition unit 15, external interface 16, and display device 17. Each part is configured to be communicable via internal interface 18. Processing device 11 may be configured using, for example, a central processing unit (CPU), a graphical processing unit (GPU), a micro processing unit (MPU), a digital signal processor (DSP), a field-programmable gate array (FPGA), or the like. Processing device 11 realizes various functions to be described later by referring to various databases (hereinafter, DB) stored in storage device 12 or reading a program, for example.

Storage device 12 is a storage unit for storing various data, programs, and the like, and may include, for example, a volatile or nonvolatile storage device such as a random access memory (RAM), a read only memory (ROM), or a hard disk drive (HDD).

Communication device 13 is an interface for communicating with an external device via network 35. The communication standard that can be supported by communication device 13 is not particularly limited, and it may be wired or wireless. The communication device may be compatible with a plurality of communication standards. Thus, network 35 may be configured by combining networks based on a plurality of communication standards.

Input device 14 receives an operation or an instruction from a user (for example, an administrator or a worker) of the warehouse. Input device 14 may include a mouse, a keyboard, and a touch panel display.

Image acquisition unit 15 is an interface for acquiring an image of the inside of the warehouse from camera 30 installed in the warehouse.

External interface 16 is an interface for communicating with external system 20. External interface 16 may be communicably connected to external system 16 via communication device 13 and network 35. External system 20 is not limited to each system illustrated in FIG. 1, and it may be another system.

Display device 17 displays various user interfaces for the user. Display device 17 may include a liquid crystal display, a touch panel display, and a lamp.

### Overview of warehouse

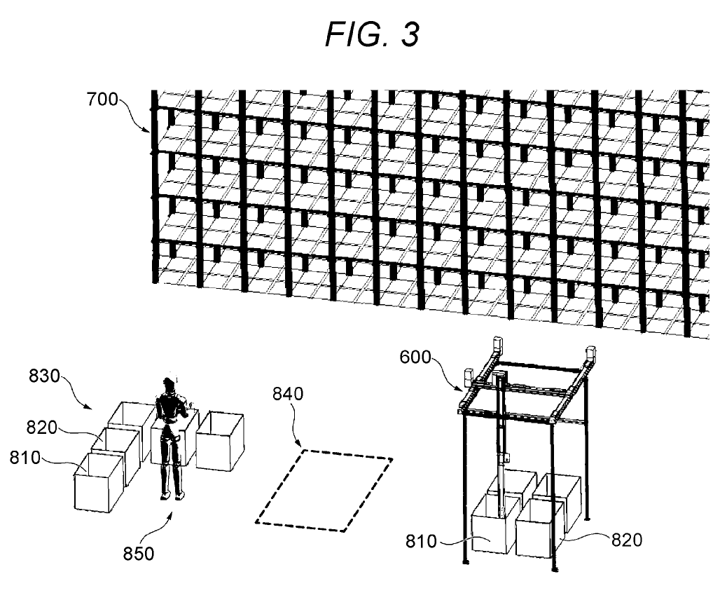

FIG. 3 is a conceptual diagram illustrating a configuration example of the inside of the warehouse of warehouse system 1 according to the present exemplary embodiment. Automated storage 1 hour of admin leave todayand one or more robots 600 are installed in the warehouse. In addition, in the warehouse, a plurality of automated guided vehicles 800 that convey bins are disposed so as to be able to travel.

Work area 830 in which worker 850 as a work entity of a picking work is provided in the periphery of automated storage 700. A work area for robot 600 to perform work is also provided. An arrangement of bins is determined which is more efficient when an entity who performs work moves products from a storage bin to a shipment bin. In addition, from the viewpoint of improving the efficiency of the entire shipping work, when it is desirable to temporarily make a bin stand by instead of moving the bin into automated storage 700, standby area 840 for the bin to stand by is provided. Hereinafter, an area where picking work is performed may be referred to as a picking station.

In the example of FIG. 3, one area where worker 850 who is a person works and one area where robot 600 works are provided, but this configuration is not limited to this example. A plurality of areas may be provided for each area. Alternatively, only one of the areas where a person works and where a robot works may be provided. In addition, although an example in which robot 600 including an orthogonal mechanism is installed as robot 600 is illustrated, a robot including a multi-axis arm may be installed.

In the first exemplary embodiment, a description will be given assuming a shipping stage in which the picking work of the product from the storage bin 810 to the delivery bin 820 is performed. In the shipping operation, it is assumed that the picking operation of the product from the storage bin 810 to the delivery bin 820 is performed by a person (worker 850) or the robot 600. A work area as illustrated in FIG. 3 as work area 830 is set, for example, as an area where the shipping work is performed. In the work area, one or more storage bins 810 and delivery bins 820 are arranged around the area for the task assignee (worker 850 or robot 600). Further, operation terminal 900 is installed in the work area in which worker 850 works.

### Emergency order allocation method

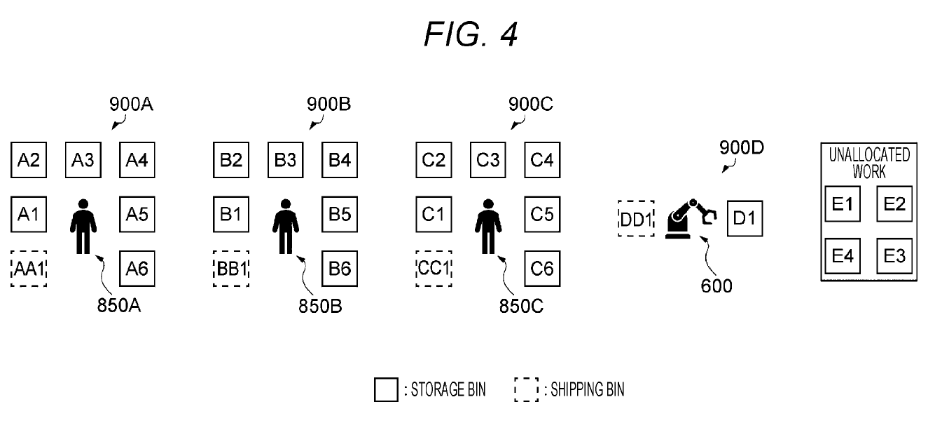

An example of work space in warehouse
FIG. 4 is a conceptual diagram illustrating an example of a work space in a warehouse of warehouse system 1 according to the first exemplary embodiment. In the example illustrated in FIG. 4, the work space in the warehouse is provided with work area 900A for worker 850A to perform work, work area 900B for worker 850B to perform work, work area 900C for worker 850C to perform work, and work area 900D for robot 600 to perform work. This work space is provided, for example, around automated storage 700, and a plurality of automated guided vehicles 800 are arranged so as to be able to travel.

In work area 900A, one delivery bin AA1 and six storage bins A1 to A6 are arranged. Delivery bin AA1 is delivery bin 820 related to the order under work. Storage bins A1 to A6 are storage bins 810 related to the order under work or storage bins 810 related to the next order.

In work area 900B, one delivery bin BB1 and six storage bins B1 to B6 are arranged. Delivery bin BB1 is delivery bin 820 related to the order under work. Storage bins B1 to B6 are storage bins 810 related to the order under work or storage bins 810 related to the next order.

In work area 900C, one delivery bin CC1 and six storage bins C1 to C6 are arranged. Delivery bin CC1 is delivery bin 820 related to the order under work. Storage bins C1 to C6 are storage bins 810 related to the order under work or storage bins 810 related to the next order.

In work area 900D, one delivery bin DD1 and one storage bin D1 are arranged. Delivery bin DD1 is delivery bin 820 related to the order under work. Storage bin D1 is storage bin 810 related to the order under work.

A plurality of orders (also referred to as “order batches”) is allocated to each of work areas 900A to 900D, and each task assignee performs the picking work according to the allocated order. In addition, in each of work areas 900A to 900D, storage bin 810 or delivery bin 820 corresponding to an order allocated to the work area is conveyed by automated guided vehicle 800.

### SUMMARY

Hereinafter, a method for allocating an emergency order when warehouse operation management system 200 acquires the emergency order from warehouse management system 100 in warehouse system 1 having an example of the work space described above will be described. The emergency order allocation method according to the first exemplary embodiment includes a first emergency order allocation method for sequentially moving an emergency delivery bin related to an emergency order to each work area and processing the emergency order by a plurality of task assignees, and a second emergency order allocation method for moving an emergency storage bin related to an emergency order to one work area and processing the emergency order by one task assignee. In the emergency order allocation method according to the first exemplary embodiment, for example, the first emergency order allocation method or the second emergency order allocation method is selected by the user of the warehouse at a predetermined timing such as when an emergency order is acquired or preset, and the selected first emergency order allocation method or second emergency order allocation method is performed.

### Overview of first emergency order allocation method

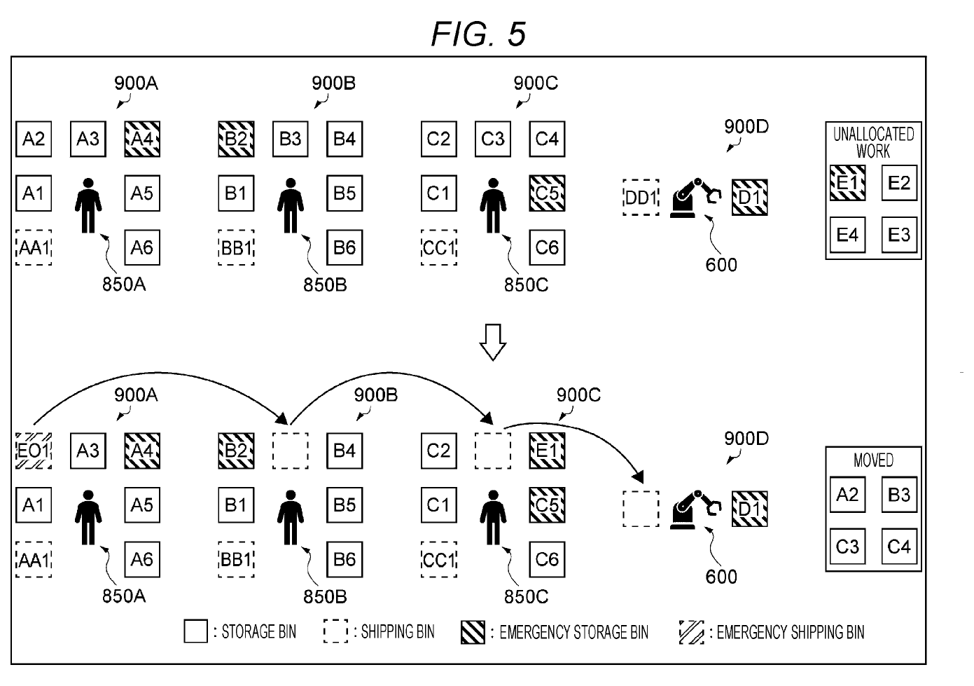

FIG. 5 is a conceptual diagram illustrating a first emergency order allocation method according to the first exemplary embodiment. As described above, the first emergency order allocation method is a method for sequentially moving emergency delivery bin EO1 related to the emergency order to each of work areas 900A to 900D and causing a plurality of task assignees to process the emergency order.

When warehouse operation management system 200 acquires the emergency order having a higher urgency than the normal order from warehouse management system 100, the warehouse operation management system selects the work area to which the emergency order is allocated based on the work information on the order batch already allocated to each of the work areas 900A to 900D, the emergency storage bin information, and the specification information on the specification of robot 600.

The work information referred to in the present specification includes, for example, information regarding an order during work in each of work areas 900A to 900D, information regarding a storage bin arranged in each of work areas 900A to 900D, and information regarding a next order. In addition, the emergency storage bin information referred to in the present specification includes, for example, information regarding a position, a type, and the like of the emergency storage bin. In addition, the specification information referred to in the present specification includes, for example, an allowable load, a picking speed, and a gripping ability.

First, warehouse operation management system 200 determines whether the emergency storage bin is included in the storage bin related to the order under work in each of work areas 900A to 900D. In other words, it is determined whether or not at least one emergency storage bin related to the emergency order is arranged in any one of work areas 900A to 900D. In this example, storage bins A4, B2, C5, D1, E1 are emergency storage bins. That is, in the present example, storage bins A4, B2, C5, D1 are the emergency storage bins included in the storage bins related to the order under work.

When an emergency storage bin is included in a storage bin related to an order under work in each of work areas 900 A to 900D, warehouse operation management system 200 determines whether or not there is an unallocated emergency storage bin. In other words, it is determined whether or not there is an emergency storage bin not arranged in any of work areas 900A to 900D among all the emergency storage bins related to the emergency order. In this example, storage bin E1 is an unallocated emergency storage bin.

Through the above two steps, it is determined whether or not all the emergency storage bins related to the emergency order are arranged in any of work areas 900A to 900D.

When all the emergency storage bins related to the emergency order are arranged in any of work areas 900A to 900D, warehouse operation management system 200 determines the work area in which the emergency storage bins are arranged as the work area to which the emergency order is allocated. In the present example, if there is no unallocated emergency storage bin E1, all of emergency storage bins A4, B2, C5, D1 are arranged in any of work areas 900A to 900D, and thus an emergency order is allocated to work areas 900A to 900D. However, herein, when a work area in which the task assignee is robot 600 is included in each work area to which the emergency order is allocated, the second urgency determination processing (refer to description below) is executed.

Meanwhile, when at least one emergency storage bin related to the emergency order is not arranged in any of work areas 900A to 900D, warehouse operation management system 200 determines a conveyance destination of an unallocated emergency storage bin. That is, any one of work areas 900A to 900D is selected as the conveyance destination. Herein, any one of work areas 900A to 900D is selected as the conveyance destination based on the distance to automated storage 700 or standby area 840 in which the emergency storage bin is arranged, the order in which emergency delivery bin EO1 is conveyed, the result of the first urgency determination processing (refer to description below), and the like. In this example, work area 900C is a work area selected as a conveyance destination. Then, warehouse operation management system 200 determines the work area in which the emergency storage bin is arranged as the work area to which the emergency order is allocated. When a work area in which the task assignee is robot 600 is included in each work area to which the emergency order is allocated, the second urgency determination processing (refer to description below) may be executed.

Through the above steps, the work area to which the emergency order is allocated is determined. That is, in this example, the emergency order is allocated to all of work areas 900A to 900D.

After the allocation of the emergency order is completed, warehouse operation management system 200 sequentially conveys emergency delivery bin EO1 to work areas 900A to 900D to which the emergency order is allocated. In this example, the emergency delivery bin EO1 is conveyed by automated guided vehicle 800 in the order of work areas 900A, 900B, 900C, and 900D. During conveyance of emergency delivery bin EO1, it is necessary to move (displace) the storage bin already arranged to receive emergency delivery bin EO1 in each of work areas 900A to 900D according to the relationship of the arrangement upper limit of the bins. Therefore, a storage bin to be moved is selected based on the work information of each of work areas 900A to 900D. In this example, it is assumed that storage bins A2, B3, C3, C4 are selected as the storage bins to be moved. As the selection of these storage bins A2, B3, C3, C4, it is preferable that storage bins A2, B3, C3, C4 are storage bins in which a work is completed and in which an article that has already been picked is stored, but storage bins A2, B3, C3, C4 may be storage bins in which an article that is being picked (in the middle of work) is stored and are in the middle of work. Storage bins A2, B3, C3, C4 selected as described above are moved to automated storage 700, standby area 840, or the like by automated guided vehicle 800. In the above description, the case where the storage bin is moved has been described as an example, but the delivery bin may be moved. In addition, there is a case where it is necessary to move the delivery bin, and thus the bin to be moved is appropriately determined.

Thereafter, the emergency order is processed by the task assignee in each of work areas 900A to 900D. Then, when the processing of the emergency order is completed, warehouse operation management system 200 acquires the processing completion notification of the emergency order for each of work areas 900A to 900D.

When acquiring the processing completion notification of the emergency order, warehouse operation management system 200 determines whether or not the storage bin moved to receive emergency delivery bin EO1 has been moved to automated storage 700. In this example, it is determined whether storage bin A2 moved from work area 900A has been moved to automated storage 700. The determination is similarly performed for storage bins B3, C3, C4 moved from work areas 900B to 900D, respectively.

When the storage bin that has been moved away to receive emergency delivery bin EO1 is moved to automated storage 700, warehouse operation management system 200 determines whether the storage bin is in the middle of work.

Through the above two steps, in each of work areas 900A to 900D to which the emergency order is allocated, the storage bin to be arranged in the empty space for receiving emergency delivery bin EO1 is determined.

When the storage bin that has been moved away to receive emergency delivery bin EO1 has not been moved to automated storage 700, the storage bin is considered to be arranged in a different work area. In addition, when the corresponding storage bin is not in the middle of operation, it is considered that the work for the corresponding storage bin has been completed. Therefore, in these cases, warehouse operation management system 200 conveys the storage bin related to the next order to the corresponding work area. In this example, storage bins E2 to E4 different from storage bin A2 are conveyed in work area 900A. Similarly, in work areas 900B to 900D, storage bins E2 to E4 different from storage bins B3, C3, C4, respectively, are conveyed.

Meanwhile, when the corresponding storage bin is in the middle of work, it is necessary to complete the processing of the order immediately before responding to the emergency order (referred to as “order in work” above). Therefore, in this case, warehouse operation management system 200 conveys the corresponding storage bin to the original work area. In the present example, storage bin A2 is conveyed to work area 900A, which is the original work area. Storage bins B3, C3, C4 are similarly conveyed to original work areas 900B to 900D, respectively.

Through the above steps, the work area to which the emergency order is allocated is restored to the normal order. The flow of recovery to the normal order in the work area to which the emergency order is allocated is not limited to the above. For example, in a work area (in this example, the work area 900C) in which an unallocated emergency storage bin has been conveyed, if a normal order using the unallocated emergency storage bin (in this example, storage bin E1) has been allocated, the order may be adjusted to be processed first.

### Overview of second emergency order allocation method

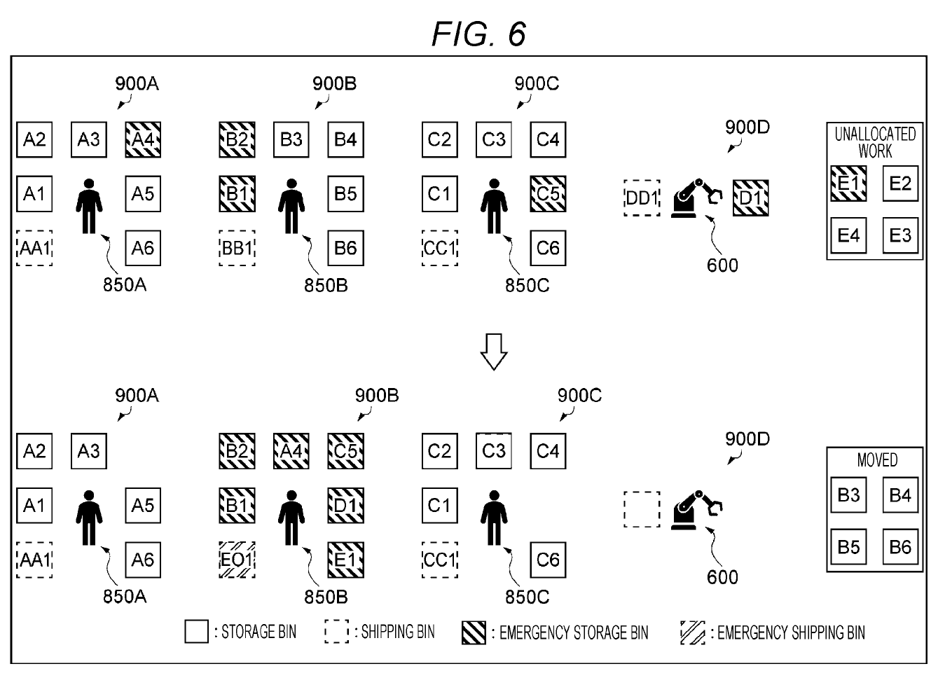

FIG. 6 is a conceptual diagram illustrating a second emergency order allocation method according to the first exemplary embodiment. As described above, the second emergency order allocation method is a method for moving an emergency storage bin related to an emergency order to one work area and processing the emergency order by one task assignee.

When warehouse operation management system 200 acquires the emergency order from warehouse management system 100, the warehouse operation management system selects the work area to which the emergency order is allocated based on the work information on the order batch already allocated to each of the work areas 900A to 900D, the emergency storage bin information, and the specification information on the specification of robot 600.

First, warehouse operation management system 200 determines whether the emergency storage bin is included in the storage bin related to the order under work in each of work areas 900A to 900D. In other words, it is determined whether or not at least one emergency storage bin related to the emergency order is arranged in any one of work areas 900A to 900D. In this example, storage bins A4, B1, B2, C5, D1, E1 are emergency storage bins. That is, in the present example, storage bins A4, B1, B2, C5, D1 are the emergency storage bins included in the storage bins related to the order under work.

When at least one emergency storage bin related to the emergency order is arranged in any of work areas 900A to 900D, warehouse operation management system 200 specifies a task assignee in work areas 900A to 900D in which the emergency storage bins are arranged. The specification of the task assignee herein is to specify any of three patterns of only worker 850 (person), only robot 600, or both worker 850 and robot 600 as the task assignee. In this example, it is specified that both worker 850 and robot 600 are task assignees. Then, warehouse operation management system 200 executes work area selection processing for selecting a work area to which the emergency order is allocated based on the specified result.

Meanwhile, when all the emergency storage bins related to the emergency order are not arranged in any of work areas 900A to 900D, warehouse operation management system 200 determines whether or not there is a work area in which at least one emergency storage bin related to the emergency order is included in the storage bin related to the next order in each of work areas 900A to 900D. This step is for recovering from an emergency order to a normal order.

When there is a work area including at least one emergency storage bin related to the emergency order in the storage bin related to the next order, warehouse operation management system 200 specifies a task assignee in the corresponding work area, and executes work area selection processing for selecting a work area to which the emergency order is allocated based on the specified result (determination result).

Meanwhile, when there is no work area including at least one emergency storage bin related to the emergency order in the storage bin related to the next order, that is, when all the emergency storage bins related to the emergency order are not included in the storage bins related to the next order of each of work areas 900A to 900D, warehouse operation management system 200 allocates the emergency order to the work area in which the remaining workload is the smallest and the worker is a task assignee.

Herein, an overview of the work area selection processing will be described.

When only the worker (person) is a task assignee, warehouse operation management system 200 selects the work area to which the emergency order is allocated based on the number of work areas in which the emergency storage bins are arranged and the number of emergency storage bins held between the work areas in which the emergency storage bins are arranged. The task assignee in the work area selected herein is a worker in each case (refer to description below).

When only the robot is a task assignee, warehouse operation management system 200 selects a work area to which the emergency order is allocated based on the number of emergency storage bins related to the emergency order, the urgency of the emergency order, the tact time of the worker related to the emergency order, the tact time of the robot, and the specification information of the robot. The task assignee in the work area selected herein is a worker or a robot (refer to description below).

When the task assignees are both the worker (person) and the robot, warehouse operation management system 200 selects the work area to which the emergency order is allocated based on the specification information of the robot, the urgency of the emergency order, the takt time of the worker related to the emergency order, and the takt time of the robot. The task assignee in the work area selected herein is a worker or a robot (refer to description below).

Through the above steps, the work area to which the emergency order is allocated is determined. In this example, an emergency order is allocated to work area 900B.

After the allocation of the emergency order is completed, warehouse operation management system 200 conveys the emergency storage bin and the emergency delivery bin to the work area to which the emergency order is allocated. In this example, emergency delivery bin EO1 and emergency storage bins A4, C5, D1, E1 are conveyed to work area 900B by automated guided vehicle 800. During conveyance of the emergency delivery bin EO1 and the emergency storage bins A4, C5, D1, E1, it is necessary to move (displace) the already arranged bins to receive these bins in work area 900B due to the relationship of the arrangement upper limit of the bins. Therefore, the bins to be moved are selected based on the work information of work area 900B. In this example, delivery bin BB1 and storage bins B3 to B6 are selected bins to be moved. As the selection of storage bins B3 to B6 herein, it is preferable that storage bins A2, B3, C3, C4 are storage bins in which an operation is completed and in which an article that has already been picked is stored, but storage bins A2, B3, C3, C4 may be storage bins in which an article that is being picked (in the middle of operation) is stored and in the middle of operation. Storage bins B3 to B6 selected as described above are moved to automated storage 700, standby area 840, or the like by automated guided vehicle 800.

Thereafter, the emergency order is processed by the task assignee in the corresponding work area. In this example, worker 850B processes the emergency order. Then, when the processing of the emergency order is completed, warehouse operation management system 200 acquires a processing completion notification of the emergency order from the corresponding work area (in this example, work area 900B).

When acquiring the processing completion notification of the emergency order, warehouse operation management system 200 determines whether or not particularly the storage bin moved away to receive the emergency storage bin has been moved to automated storage 700. In this example, it is determined whether storage bins B3 to B6 moved from work area 900B have been moved to automated storage 700.

When the storage bins that were moved away to receive the emergency storage bins have been moved to automated storage 700, warehouse operation management system 200 determines whether or not the storage bins that have been conveyed as emergency storage bins have been conveyed from other work areas.

When a storage bin that has been conveyed as an emergency storage bin has been conveyed from another work area, warehouse operation management system 200 determines whether the corresponding storage bin has been in the middle of operation.

Through the above three steps, the transport destination of the emergency storage bin moved to the work area to which the emergency order is allocated is determined at the time of recovery to the normal order.

When the storage bin that was moved away to receive an emergency storage bin has not been moved to the automated storage 700, the storage bin is considered to be arranged in a different work area. Therefore, in this case, warehouse operation management system 200 conveys the storage bin related to the next order to the corresponding work area. In this example, storage bins E2 to E4 and the like different from storage bins B3 to B6 are conveyed to work area 900B.

When the storage bins that have been conveyed as emergency storage bins have not been conveyed from other work areas, the storage bins are considered to have been conveyed from automated storage 700. In this example, storage bin E1 corresponds thereto. In addition, when a storage bin conveyed as an emergency storage bin from another work area is not in the middle of work, the work for the corresponding storage bin is considered to have been completed. Therefore, in these cases, warehouse operation management system 200 causes the corresponding storage bin to be conveyed to automated storage 700 and then to the corresponding work area.

Meanwhile, when the storage bin carried as the emergency storage bin from another work area is in the middle of work, it is necessary to complete the processing of the order that was in work immediately before the emergency order in another work area. Therefore, in this case, warehouse operation management system 200 conveys the corresponding storage bin to the original work area. In this example, for example, storage bins A4, C5, D1 are conveyed to work areas 900A, 900C, 900D, respectively. Thereafter, warehouse operation management system 200 conveys the storage bin related to the next order to the corresponding work area.

Through the above steps, the work area affected by the emergency order is restored to the normal order. The flow of recovery to the normal order in the work area to which the emergency order is allocated is not limited to the above. For example, the work area to which the emergency order is allocated may be adjusted by allocating the order using the storage bin conveyed as the emergency storage bin.

### Processing flow according to first emergency order allocation method

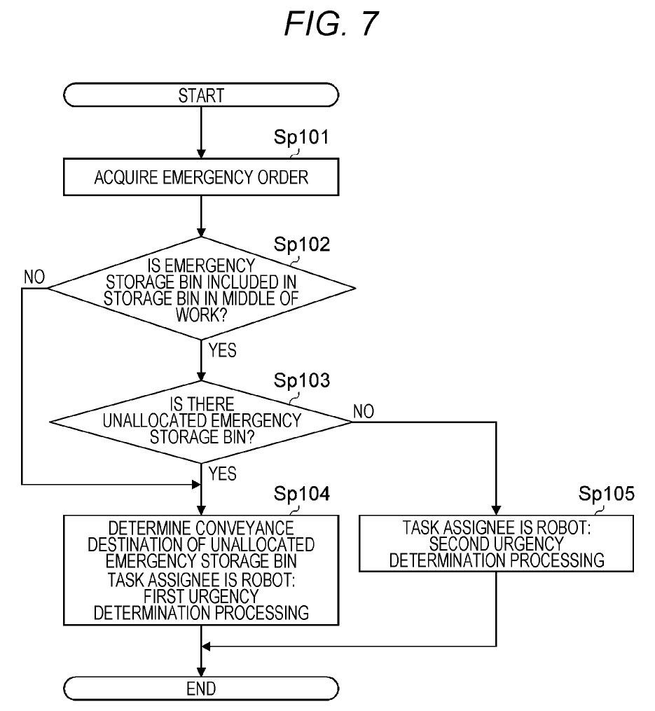

Emergency order allocation process
FIG. 7 is a flowchart for describing a flow of processing of emergency order allocation in the first emergency order allocation method according to the first embodiment. The following processing flow is executed when an emergency order is transmitted from warehouse management system 100 to warehouse operation management system 200. In the present example, the processing entity will be described as warehouse operation management system 200, but some functions may be configured to be executed by another system.

Warehouse operation management system 200 (for example, processing device 11, the same applies hereinafter) acquires the emergency order from warehouse management system 100 that is the host system (step Sp101).

Warehouse operation management system 200 determines whether at least one emergency storage bin related to the emergency order is included in the storage bin related to the order under work in each work area (step Sp102). When it is determined that at least one emergency storage bin is included in the storage bin related to the order under work (YES in step Sp102), the processing of warehouse operation management system 200 proceeds to step Sp103. Meanwhile, when it is determined that the emergency storage bin is not included in the storage bin related to the order under work (NO in step Sp102), the processing of warehouse operation management system 200 proceeds to step Sp104. At this stage, the work area in which the emergency storage bins are arranged is an allocation target of the emergency order.

Warehouse operation management system 200 determines whether or not there is an unallocated emergency storage bin that is not arranged in any of the work areas among all the emergency storage bins related to the emergency order (step Sp103). When it is determined that there is an unallocated emergency storage bin (YES in step Sp103), the processing of warehouse operation management system 200 proceeds to step Sp104. Meanwhile, when it is determined that there is not an unallocated emergency storage bin (NO in step Sp103), the processing of warehouse operation management system 200 proceeds to step Sp105.

Warehouse operation management system 200 determines the work area to which the unallocated emergency storage bin is to be conveyed based on the distance between automated storage 700 in which the unallocated emergency storage bin is arranged and each work area, the order in which the emergency delivery bin is conveyed, the result of the first urgency determination processing (refer to description below), and the like (step Sp104). When a work area in which the task assignee is robot 600 is included in the work area to which the emergency order is allocated, the second urgency determination processing (refer to description below) may be executed.

When the work area to which the emergency order is allocated includes a work area in which the task assignee is robot 600, warehouse operation management system 200 executes second urgency determination processing (refer to description below) (step Sp105). When the work area to which the emergency order is allocated does not include the work area in which the task assignee is robot 600, this step is omitted. Then, the present processing flow ends.

Through the above processing flow, warehouse operation management system 200 determines the work area in which the emergency storage bins are arranged as the work area to which the emergency order is allocated. As a result, the emergency order allocation processing is completed. Thereafter, warehouse operation management system 200 executes a processing of conveying the unallocated emergency storage bins to the determined destination, sequentially conveying the emergency delivery bins to the work area to which the emergency order is allocated, or moving the storage bins already arranged in each work area to receive the emergency delivery bins.

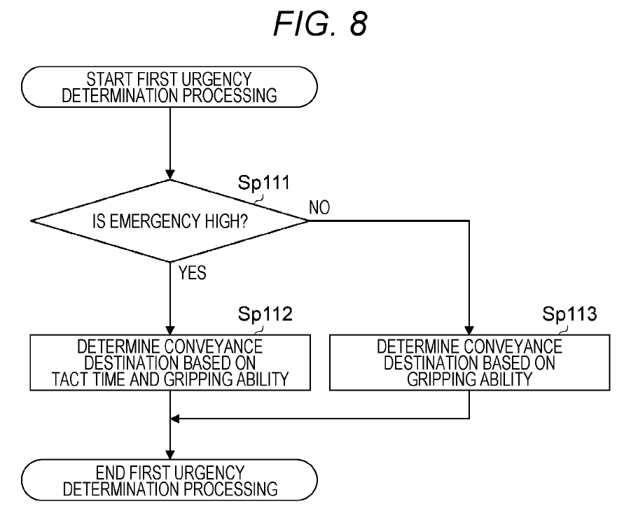

First urgency determination processing
FIG. 8 is a flowchart for explaining a flow of the first urgency determination processing in the first emergency order allocation method according to the first exemplary embodiment. The following processing flow is executed in a case where the work area to which the emergency order is allocated includes the work area in which the task assignee is robot 600 in step Sp104 in the above-described emergency order allocation processing.

Warehouse operation management system 200 determines whether the urgency of the emergency order is high based on the delivery time of the article related to the emergency order (step Sp111). When it is determined that the urgency of the emergency order is high (YES in step Sp111), the processing of warehouse operation management system 200 proceeds to step Sp112. Meanwhile, when it is determined that the urgency of the emergency order is not high (NO in step Sp111), the processing of warehouse operation management system 200 proceeds to step Sp113.

Warehouse operation management system 200 determines a work area to be a conveyance destination based on particularly the takt time and the gripping ability in the specification information of robot 600 (step Sp112). Herein, for example, a work area in which robot 600 having the highest specification is a task assignee, or a work area in which worker 850 (person) is a task assignee when robot 600 cannot cope with the work is selected as the conveyance destination. Then, the present processing flow ends.

Warehouse operation management system 200 determines a work area to be a conveyance destination based on particularly the gripping ability in the specification information of robot 600 (step Sp113). Herein, a work area in which robot 600 capable of picking the article related to the emergency order is a task assignee is selected as the conveyance destination. Then, the present processing flow ends.

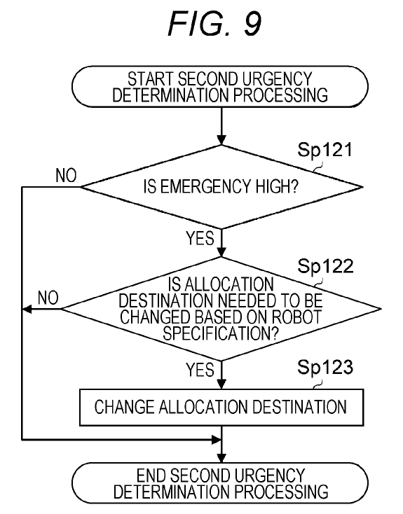

Second urgency determination processing
FIG. 9 is a flowchart for explaining a flow of the second urgency determination processing in the first emergency order allocation method according to the first exemplary embodiment. The following processing flow is executed in a case where the work area to which the emergency order is allocated includes the work area in which the task assignee is robot 600 in step Sp105 in the above-described emergency order allocation processing.

Warehouse operation management system 200 determines whether the urgency of the emergency order is high based on the delivery time of the article related to the emergency order (step Sp121). When it is determined that the urgency of the emergency order is high (YES in step Sp121), the processing of warehouse operation management system 200 proceeds to step Sp122. Meanwhile, when it is determined that the urgency of the emergency order is not high (NO in step Sp121), the processing flow ends.

Warehouse operation management system 200 determines whether or not it is necessary to change the allocation destination of the emergency order based on the specification information of the corresponding robot 600 (step Sp122). When it is determined that the allocation destination of the emergency order needs to be changed (YES in step Sp122), the processing of warehouse operation management system 200 proceeds to step Sp123. Meanwhile, when it is determined that there is no need to change the allocation destination of the emergency order (NO in step Sp122), the present processing flow ends.

Warehouse operation management system 200 changes the allocation destination of the emergency order based on the distance between automated storage 700 in which the unallocated emergency storage bins are arranged and each work area, the order in which the emergency delivery bins are conveyed, and the like (step Sp123). Then, the present processing flow ends.

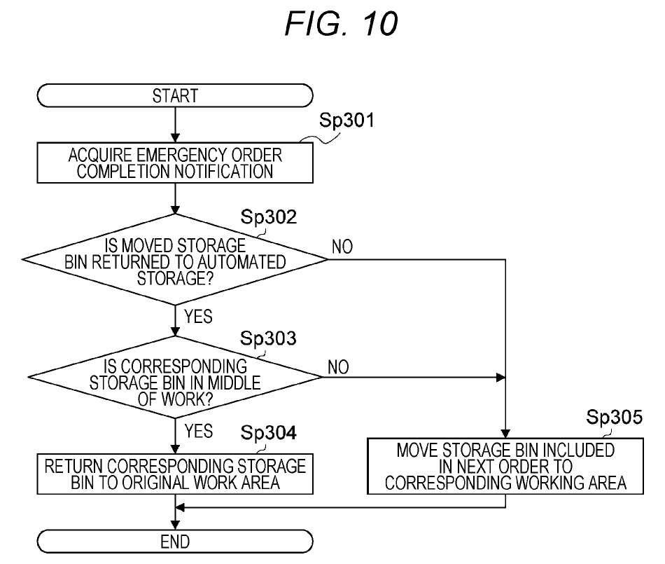

Recovery processing
FIG. 10 is a flowchart for explaining a flow of recovery processing from an emergency order to a normal order in the first emergency order allocation method according to the first exemplary embodiment. The following processing flow is executed when a processing completion notification of the emergency order is transmitted from the work area to which the emergency order is allocated to warehouse operation management system 200.

Warehouse operation management system 200 acquires the processing completion notification of the emergency order from the work area to which the emergency order is allocated via, for example, warehouse control system 300 and operation terminal 900, which are the subordinate systems (step Sp301).

Warehouse operation management system 200 determines whether the storage bin moved to receive the emergency delivery bin has returned to automated storage 700 (step Sp302). When it is determined that the corresponding storage bin has returned to automated storage 700 (YES in step Sp302), the processing of warehouse operation management system 200 proceeds to step Sp303. Meanwhile, when it is determined that the corresponding storage bin has not returned to automated storage 700 (NO in step Sp302), the processing of warehouse operation management system 200 proceeds to step Sp305.

Warehouse operation management system 200 determines whether or not the corresponding storage bin is a storage bin related to an order in the middle of work (step Sp303). When it is determined that the corresponding storage bin is the storage bin related to the order in the middle of work (YES in step Sp303), the processing of warehouse operation management system 200 proceeds to step Sp304. Meanwhile, when it is determined that the corresponding storage bin is not the storage bin related to the order in the middle of work (NO in step Sp303), the processing of warehouse operation management system 200 proceeds to step Sp305.

Warehouse operation management system 200 conveys the corresponding storage bin to the original work area (step Sp304). Then, the present processing flow ends.

Warehouse operation management system 200 conveys the storage bin related to the next order to the corresponding work area (step Sp305). Then, the present processing flow ends.

### Processing flow according to second emergency order allocation method

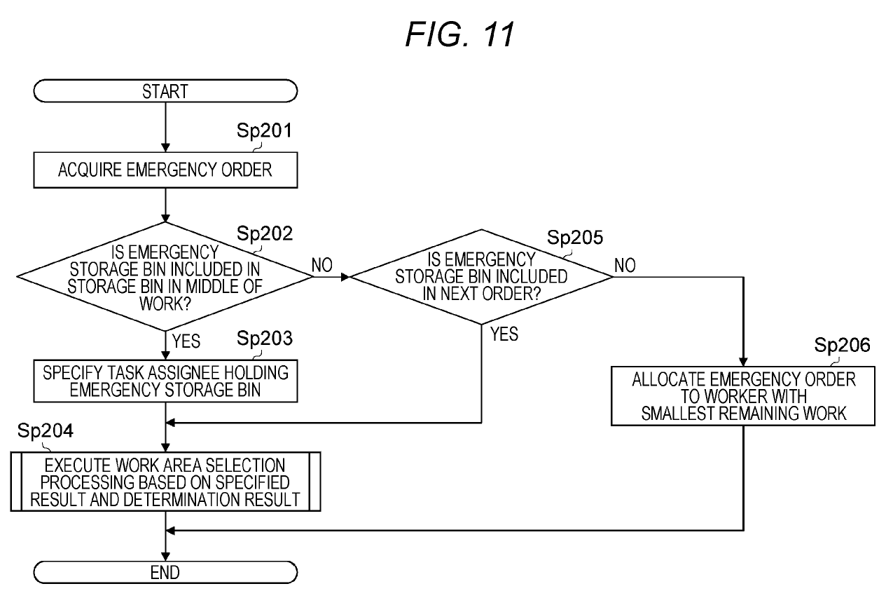

Emergency order allocation process
FIG. 11 is a flowchart for describing a flow of processing of emergency order allocation in the second emergency order allocation method according to the first embodiment. The following processing flow is executed when an emergency order is transmitted from warehouse management system 100 to warehouse operation management system 200.

Warehouse operation management system 200 (for example, processing device 11, the same applies hereinafter) acquires the emergency order from warehouse management system 100 that is the host system (step Sp201).

Warehouse operation management system 200 determines whether at least one emergency storage bin related to the emergency order is included in the storage bin related to the order under work in each work area (step Sp202). When it is determined that at least one emergency storage bin is included in the storage bin related to the order under work (YES in step Sp202), the processing of warehouse operation management system 200 proceeds to step Sp203. Meanwhile, when it is determined that the emergency storage bin is not included in the storage bin related to the order under work (NO in step Sp202), the processing of warehouse operation management system 200 proceeds to step Sp205.

Warehouse operation management system 200 specifies the task assignee in the work area in which the emergency storage bins are arranged (step Sp203).

Warehouse operation management system 200 executes the work area selection processing related to the task assignee in the work area in which the emergency storage bins are arranged based on the specified result and the determination result (Step Sp204). Then, the present processing flow ends.

Warehouse operation management system 200 determines whether or not there is a work area in which at least one emergency storage bin related to the emergency order is included in the storage bins related to the next order in each work area (step Sp205). When it is determined that there is a work area including at least one emergency storage bin related to the emergency order in the storage bins related to the next order (YES in step Sp205), the processing of warehouse operation management system 200 proceeds to step Sp204. Meanwhile, when there is no work area including at least one emergency storage bin related to the emergency order in the storage bins related to the next order (NO in step Sp205), the processing of warehouse operation management system 200 proceeds to step Sp206.

Warehouse operation management system 200 allocates the emergency order to the work area in which the worker with the smallest remaining workload is a task assignee (step Sp206). Then, the present processing flow ends.

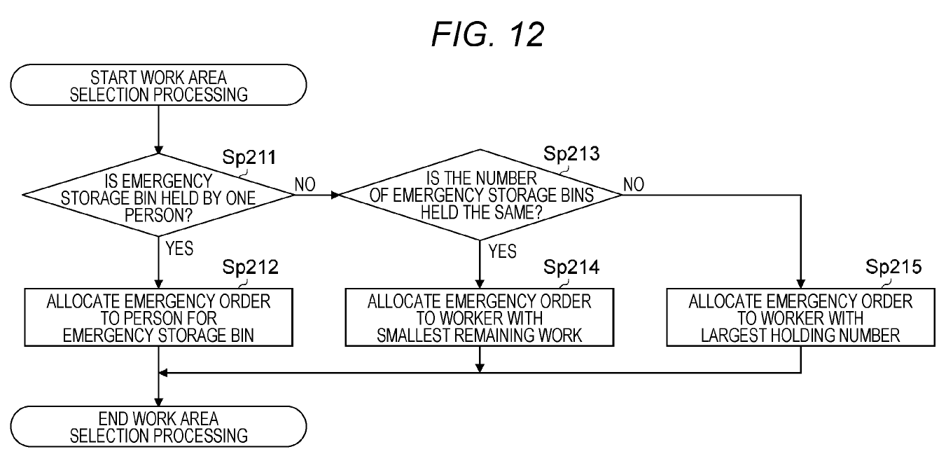

Work area selection processing: task assignee is only the worker (person)
FIG. 12 is a flowchart for explaining the flow of the work area selection processing when the task assignee is only a worker (person) in the second emergency order allocation method according to the first embodiment.

Warehouse operation management system 200 determines whether or not there is only one work area in which the emergency storage bins are arranged (step Sp211). When it is determined that there is only one work area in which the emergency storage bins are arranged (YES in step Sp211), the processing of warehouse operation management system 200 proceeds to step Sp212. Meanwhile, when it is determined that there is not only one (there is a plurality of) work area in which the emergency storage bins are arranged (NO in step Sp211), the processing of warehouse operation management system 200 proceeds to step Sp213.

Warehouse operation management system 200 allocates the emergency order to the work area in which the emergency storage bins are arranged (step Sp212). Then, the present processing flow ends.

Warehouse operation management system 200 determines whether or not the numbers of the emergency storage bins held between the work areas in which the emergency storage bins are arranged are the same (step Sp213). When it is determined that the numbers of the emergency storage bins held between the work areas in which the emergency storage bins are arranged are the same (YES in step Sp213), the processing of warehouse operation management system 200 proceeds to step Sp214. Meanwhile, when it is determined that the numbers of the emergency storage bins held in each of work areas in which the emergency storage bins are arranged are not the same (NO in step Sp213), the processing of warehouse operation management system 200 proceeds to step Sp215.

Warehouse operation management system 200 allocates the emergency order to the work area with the smallest remaining workload (step Sp214). Then, the present processing flow ends.

Warehouse operation management system 200 allocates the emergency order to the work area having the largest number of emergency storage bins (step Sp215). Then, the present processing flow ends.

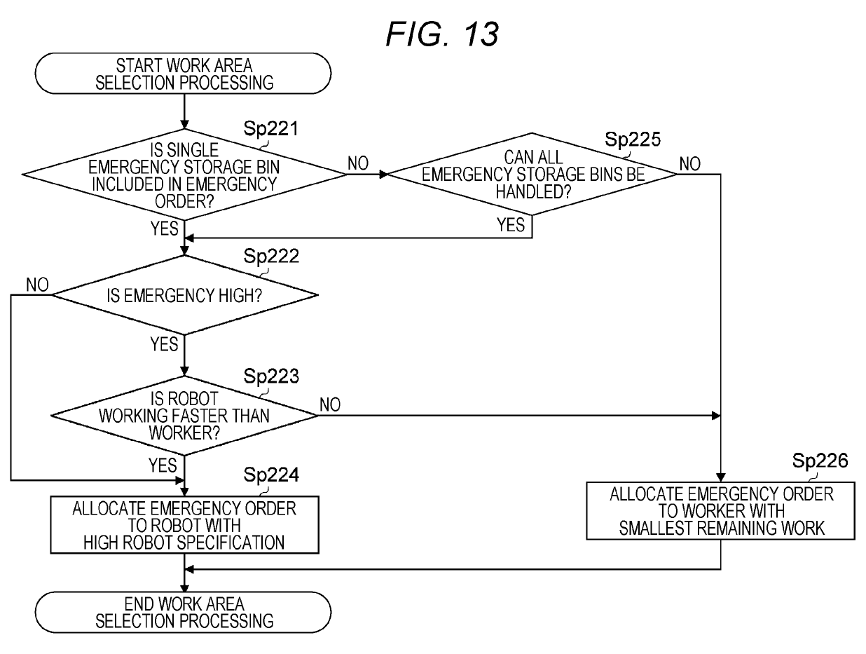

Work area selection processing: task assignee is only the robot
FIG. 13 is a flowchart for explaining the flow of the work area selection processing when the task assignee is only a robot in the second emergency order allocation method according to the first embodiment.

Warehouse operation management system 200 determines whether or not there is one emergency storage bin related to the emergency order (step Sp221). When it is determined that there is one emergency storage bin related to the emergency order (YES in step Sp221), the processing of warehouse operation management system 200 proceeds to step Sp222. Meanwhile, when it is determined that there is not one (there is a plurality of) emergency storage bin related to the emergency order (NO in step Sp221), the processing of warehouse operation management system 200 proceeds to step Sp225.

Warehouse operation management system 200 determines whether the urgency of the emergency order is high based on the delivery time of the article related to the emergency order (step Sp222). When it is determined that the urgency of the emergency order is high (YES in step Sp222), the processing of warehouse operation management system 200 proceeds to step Sp223. When it is determined that the urgency of the emergency order is not high (NO in step Sp222), the processing of warehouse operation management system 200 proceeds to step Sp224.

Warehouse operation management system 200 determines whether the takt time of the robot is shorter than that of the worker based on the worker information, the specification information, and the like (step Sp223). When it is determined that the takt time of the robot is shorter than that of the worker (YES in step Sp223), the processing of warehouse operation management system 200 proceeds to step Sp224. Meanwhile, when it is determined that the takt time of the robot is longer than that of the worker (NO in step Sp223), the processing of warehouse operation management system 200 proceeds to step Sp226.

Warehouse operation management system 200 allocates the emergency order to the work area in which the robot having the highest specification (for example, the takt time is the shortest) is a task assignee (step Sp224). Then, the present processing flow ends.

Warehouse operation management system 200 determines whether or not all the emergency storage bins related to the emergency order can be handled based on the specification information of each robot (step Sp225). When it is determined that all the emergency storage bins related to the emergency order can be handled (YES in step Sp225), the processing of warehouse operation management system 200 proceeds to step Sp222. Meanwhile, when it is determined that all the emergency storage bins related to the emergency order cannot be handled (NO in step Sp225), the processing of warehouse operation management system 200 proceeds to step Sp226.

Warehouse operation management system 200 allocates the emergency order to the work area in which the worker with the smallest remaining workload is a task assignee (step Sp226). Then, the present processing flow ends.

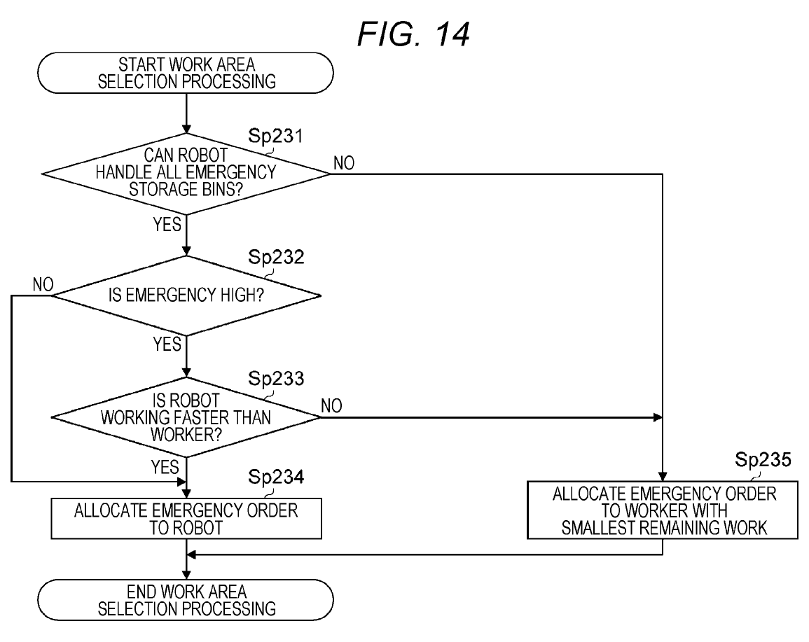

Work area selection processing: both the worker (person) and the robot are task assignees
FIG. 14 is a flowchart for explaining a flow of work area selection processing in a case where the task assignee is both a worker (person) and a robot in the second emergency order allocation method according to the first exemplary embodiment.

Warehouse operation management system 200 determines whether or not all the emergency storage bins related to the emergency order can be handled by the robot based on the specification information of each robot (step Sp231). When it is determined that all the emergency storage bins related to the emergency order can be handled by the robot (YES in step Sp231), the processing of warehouse operation management system 200 proceeds to Sp232. Meanwhile, when it is determined that all the emergency storage bins related to the emergency order cannot be handled by the robot (NO in step Sp231), the processing of warehouse operation management system 200 proceeds to Sp235.

Warehouse operation management system 200 determines whether the urgency of the emergency order is high based on the delivery time of the article related to the emergency order (step Sp232). When it is determined that the urgency of the emergency order is high (YES in step Sp232), the processing of warehouse operation management system 200 proceeds to step Sp233. When it is determined that the urgency of the emergency order is not high (NO in step Sp232), the processing of warehouse operation management system 200 proceeds to step Sp234.

Warehouse operation management system 200 determines whether the takt time of the robot is shorter than that of the worker based on the worker information, the specification information, and the like (step Sp233). When it is determined that the takt time of the robot is shorter than that of the worker (YES in step Sp233), the processing of warehouse operation management system 200 proceeds to step Sp234. Meanwhile, when it is determined that the takt time of the robot is longer than that of the worker (NO in step Sp233), the processing of warehouse operation management system 200 proceeds to step Sp235.

Warehouse operation management system 200 allocates the emergency order to the work area in which the robot is a task assignee (step Sp234). Then, the present processing flow ends.

Warehouse operation management system 200 allocates the emergency order to the work area in which the worker with the smallest remaining workload is a task assignee (step Sp235). Then, the present processing flow ends.

Through the above processing flow, warehouse operation management system 200 determines the work area to which the emergency order is allocated. As a result, the emergency order allocation processing is completed. Thereafter, warehouse operation management system 200 executes processing of conveying the emergency delivery bin and the emergency storage bin to the work area to which the emergency order is allocated, moving the bin already arranged in the work area to which the emergency order is allocated, and the like.

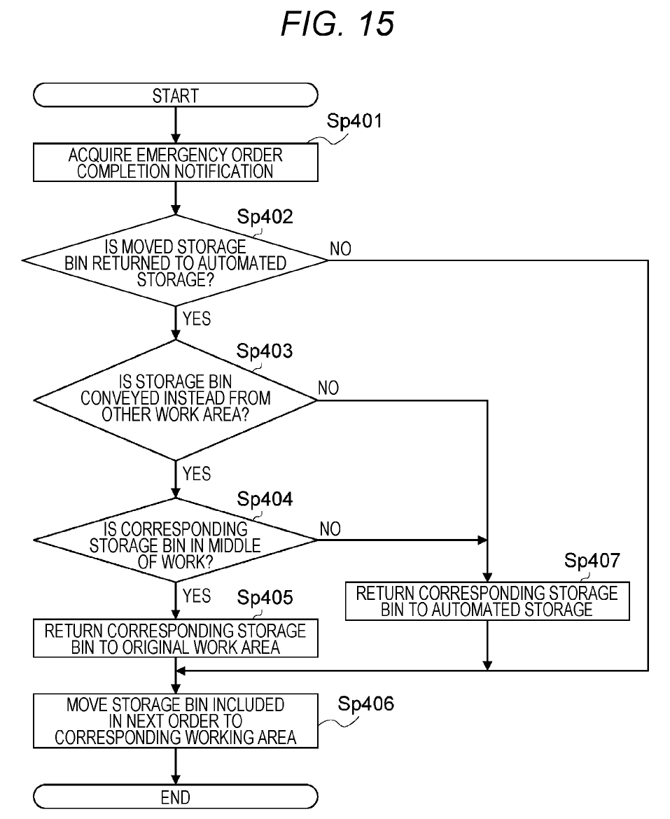

Recovery processing
FIG. 15 is a flowchart for explaining a flow of recovery processing from an emergency order to a normal order in the second emergency order allocation method according to the first exemplary embodiment. The following processing flow is executed when a processing completion notification of the emergency order is transmitted from the work area to which the emergency order is allocated to warehouse operation management system 200.

Warehouse operation management system 200 acquires the processing completion notification of the emergency order from the work area to which the emergency order is allocated via, for example, warehouse control system 300 or operation terminal 900, which are the subordinate systems (step Sp401).

Warehouse operation management system 200 determines whether the storage bin moved to receive the emergency storage bin has returned to automated storage 700 (step Sp402). When it is determined that the corresponding storage bin has returned to automated storage 700 (YES in step Sp402), the processing of warehouse operation management system 200 proceeds to step Sp403. Meanwhile, when it is determined that the corresponding storage bin has not returned to automated storage 700 (NO in step Sp402), the processing of warehouse operation management system 200 proceeds to step Sp406.

Warehouse operation management system 200 determines whether or not the storage bin conveyed as the emergency storage bin has been conveyed from another work area (step Sp403). When it is determined that the storage bin conveyed as the emergency storage bin has been conveyed from another work area (YES in step Sp403), the processing of warehouse operation management system 200 proceeds to step Sp404. Meanwhile, when it is determined that the storage bin conveyed as the emergency storage bin has not been conveyed from another work area (NO in step Sp403), the processing of warehouse operation management system 200 proceeds to step Sp407.

Warehouse operation management system 200 determines whether or not the corresponding storage bin is a storage bin related to an order in the middle of work (step Sp404). When it is determined that the corresponding storage bin is the storage bin related to the order in the middle of work (YES in step Sp404), the processing of warehouse operation management system 200 proceeds to step Sp405. Meanwhile, when it is determined that the corresponding storage bin is not the storage bin related to the order in the middle of work (NO in step Sp404), the processing of warehouse operation management system 200 proceeds to step Sp407.

Warehouse operation management system 200 conveys the corresponding storage bin to the original work area (step Sp405).

Warehouse operation management system 200 conveys the storage bin related to the next order to the corresponding work area (step Sp406). Then, the present processing flow ends.

Warehouse operation management system 200 conveys the corresponding storage bin to the automated storage (step Sp407). Then, the processing of warehouse operation management system 200 proceeds to step Sp406.

As described above, according to the first exemplary embodiment, the emergency order can be allocated to a more appropriate task assignee (work area).

### Other modification examples

A program that is for implementing the function of the device of the above-described exemplary embodiment, supplied via a network or various types of storage medium, and is read and executed by a computer in the device, and a storage medium are also within the scope of the present disclosure.

Although the various exemplary embodiments have been described above with reference to the drawings, it goes without saying that the present disclosure is not limited to such examples. It is obvious that those skilled in the art can arrive at various change examples, modification examples, replacement examples, additional examples, deletion examples, and equivalent examples within the scope described in the claims, and it is understood that these examples naturally belong to the technical scope of the present disclosure. In addition, the constituent elements included in the various exemplary embodiments described above may be voluntarily combined, within the scope not departing from the gist of the disclosure.

### (Supplementary note

The following techniques are disclosed based on the above description of the above exemplary embodiments.

### Technique 1

An order allocation method for allocating an order related to picking work acquired from an external system (for example, 100) to each work area (for example, 830, 900A to 900D) for a person (for example, 850, 850A to 850 C) or a robot (for example, 600), the order allocation method including:
an acquisition step of acquiring an emergency order from the external system; and
an allocation step of allocating the emergency order to at least one of the work areas based on work information on an order already allocated to each of the work areas, emergency storage bin information on an emergency storage bin that is a storage bin of an article related to the emergency order, and specification information on a specification of the robot.

With this configuration, an emergency order can be allocated to a more appropriate task assignee (work area) based on the arrangement status of the emergency storage bins and the specifications of the robot, and as a result, the emergency order can be processed more rapidly and efficiently than before.

### Technique 2

The order allocation method according to Technique 1, in which
in the allocation step, the emergency order is allocated to a plurality of work areas with the emergency storage bins respectively arranged, and
the order allocation method further includes a first conveyance step of sequentially conveying an emergency delivery bin that is a delivery bin of the article related to the emergency order to the plurality of work areas with the emergency order allocated.

[ 0141 ] With this configuration, the emergency order can be handled by a plurality of task assignees, and thus the emergency order can be processed more rapidly and efficiently than before. In addition, in this configuration, the emergency delivery bins may be sequentially moved to the plurality of work areas, and thus the use of the automated guided vehicle that conveys the emergency delivery bins can be minimized.

### Technique 3

The order allocation method according to Technique 2, in which
in the allocation step, when it is determined whether or not all the emergency storage bins related to the emergency order are arranged in any of the plurality of work areas based on the work information and the emergency storage bin information, and it is determined that a predetermined emergency storage bin is not arranged in any of the plurality of work areas, a predetermined work area for conveyance of the predetermined emergency storage bin is selected from the plurality of work areas.

With this configuration, the predetermined work area can be selected in consideration of the position of the predetermined emergency storage bin and the order for conveyance of the emergency delivery bin, and thus the emergency order can be processed more rapidly and more efficiently.

### Technique 4

The order allocation method according to Technique 3, in which
in the allocation step, the predetermined work area is selected based on urgency of the emergency order and the specification information.

With this configuration, an emergency order can be allocated to a more appropriate task assignee (work area), and a processing delay caused by robot specifications can be avoided.

### Technique 5

The order allocation method according to any one of Techniques 1 to 5, in which in the allocation step, when it is determined whether or not the emergency storage bin related to the emergency order is arranged in any one of a plurality of work areas based on the work information and the emergency storage bin information, and it is determined that the emergency storage bin is arranged in any one of the plurality of work areas, the order allocation method executes work area selection processing of specifying whether a person or a robot is a task assignee in a work area with the emergency storage bin arranged and selecting the work area based on the specified result such that all the emergency storage bins are aggregated into one work area.

With this configuration, it is possible to comprehensively determine the arrangement state of the emergency storage bins and the task assignee, to suppress unnecessary conveyance of the emergency storage bins, and further to allocate an emergency order to a more appropriate task assignee (work area). In addition, in this configuration, the emergency order is allocated to one work area, and thus it is easy to rearrange the work plan.

### Technique 6

The order allocation method according to Technique 5, in which when it is specified that only the person is the task assignee in the work area with the emergency storage bin arranged, in the work area selection processing, when it is determined that the work area with the emergency storage bin arranged is one location, the emergency order is allocated to the one work area with the emergency storage bin arranged.

With this configuration, it is possible to suppress unnecessary conveyance of the emergency storage bin.

### Technique 7

The order allocation method according to Technique 5 or 6, in which when it is specified that only the person is the task assignee in a work area with the emergency storage bins arranged, in the work area selection processing, when it is determined that the emergency storage bins are arranged in a plurality of work areas and it is determined that the number of the emergency storage bins arranged is the same in each of the work areas, the emergency order is allocated to a work area having the smallest remaining workload.

With this configuration, the work load can be equalized, the overall work efficiency can be enhanced, and the time loss due to the emergency order processing can be avoided.

### Technique 8

The order allocation method according to any one of Techniques 5 to 7, in which when it is specified that only the person is the task assignee in a work area with the emergency storage bins arranged, in the work area selection processing, when it is determined that the emergency storage bins are arranged in a plurality of work areas and it is determined that the number of the emergency storage bins arranged is not the same in each of the work areas, the emergency order is allocated to a work area with the largest number of the emergency storage bins arranged.

With this configuration, an emergency order can be allocated to a more appropriate task assignee (work area), and the emergency storage bins can be efficiently conveyed.

### Technique 9

The order allocation method according to any one of Techniques 5 to 8, in which when it is specified that only the robot is or both the person and the robot are the task assignee(s) in a work area with the emergency storage bins arranged, in the work area selection processing, when it is determined that the tact time related to the emergency order is shorter in the robot than in the person based on the specification information, the emergency order is allocated to a work area for the robot having the highest specification.

With this configuration, an emergency order can be allocated to a more appropriate task assignee (work area), the comprehensive work efficiency can be enhanced, and time loss due to emergency order processing can be avoided.

### Technique 10

The order allocation method according to any one of Techniques 5 to 9, in which when it is specified that only the robot is or both the person and the robot are the task assignee(s) in a work area with the emergency storage bins arranged, in the work area selection processing, when it is determined that the tact time related to the emergency order is longer in the robot than in the person based on the specification information, the emergency order is allocated to a work area for the smallest remaining workload and for the person.

With this configuration, an emergency order can be allocated to a more appropriate task assignee (work area), the comprehensive work efficiency can be enhanced, and time loss due to emergency order processing can be avoided.

### Technique 11

The order allocation method according to any one of Techniques 5 to 10, in which when it is specified that only the robot is the task assignee in the work area with the emergency storage bins arranged, in the work area selection processing, when it is determined that a number of the emergency storage bins related to the emergency order is plural and it is determined that the specification of the robot is insufficient with respect to the number of the emergency storage bins related to the emergency order, the emergency order is allocated to a work area for the smallest remaining workload and for the person.

With this configuration, an emergency order can be allocated to a more appropriate task assignee (work area), and a processing delay caused by robot specifications can be avoided.

### Technique 12

The order allocation method according to any one of Techniques 1 to 11, further including a second conveyance step of acquiring a work completion notification related to the emergency order from a work area with the emergency order allocated, then determining a work progress related to a storage bin moved in response to the emergency order, conveying the moved storage bin to an original work area when the work related to the storage bin is in a middle of being performed, and conveying a storage bin related to a next order to the original work area when the work related to the storage bin is completed.

With this configuration, overall work continuity and work efficiency are improved.

### Technique 13

An information processing device (for example, 10) that allocates an order related to picking work acquired from an external system (for example, 100) to each work area (for example, 830, 900A to 900D) for a person (for example, 850, 850A to 850C) or a robot (for example, 600), the information processing device including:
a communication unit (for example, 13) that acquires an emergency order from the external system; and
a controller (for example, 11) that allocates the emergency order to at least one of the work areas based on work information on an order already allocated to each of the work areas, emergency storage bin information on an emergency storage bin that is a storage bin of an article related to the emergency order, and specification information on a specification of the robot.

With this configuration, an emergency order can be allocated to a more appropriate task assignee (work area) based on the arrangement status of the emergency storage bins and the specifications of the robot, and as a result, the emergency order can be processed more rapidly and efficiently than before.

The present disclosure is useful as an order allocation method and an information processing device capable of allocating an emergency order to a more appropriate task assignee.

What is claimed is:

1. An order allocation method for allocating an order related to picking work acquired from an external system to each work area for a person or a robot, the order allocation method comprising:
an acquisition step of acquiring an emergency order from the external system; and
an allocation step of allocating the emergency order to at least one of the work areas based on work information on an order already allocated to each of the work areas, emergency storage bin information on an emergency storage bin that is a storage bin of an article related to the emergency order, and specification information on a specification of the robot.

2. The order allocation method according to claim 1, wherein
in the allocation step, the emergency order is allocated to a plurality of work areas with the emergency storage bins respectively arranged, and
the order allocation method further includes a first conveyance step of sequentially conveying an emergency delivery bin that is a delivery bin of the article related to the emergency order to the plurality of work areas with the emergency order allocated.

3. The order allocation method according to claim 2,
wherein in the allocation step, when it is determined whether or not all the emergency storage bins related to the emergency order are arranged in any of the plurality of work areas based on the work information and the emergency storage bin information and it is determined that a predetermined emergency storage bin is not arranged in any of the plurality of work areas, a predetermined work area for conveyance of the predetermined emergency storage bin is selected from the plurality of work areas.

4. The order allocation method according to claim 3,
wherein in the allocation step, the predetermined work area is selected based on urgency of the emergency order and the specification information.

5. The order allocation method according to claim 1,
wherein in the allocation step, when it is determined whether or not the emergency storage bin related to the emergency order is arranged in any one of a plurality of work areas based on the work information and the emergency storage bin information and it is determined that the emergency storage bin is arranged in any one of the plurality of work areas, the order allocation method executes work area selection processing of specifying whether a person or a robot is a task assignee in a work area with the emergency storage bin arranged and selecting the work area based on the specified result such that all the emergency storage bins are aggregated into one work area.

6. The order allocation method according to claim 5,
wherein when it is specified that only the person is the task assignee in a work area with the emergency storage bin arranged, in the work area selection processing, when it is determined that the work area with the emergency storage bin arranged is one location, the emergency order is allocated to the one work area with the emergency storage bin arranged.

7. The order allocation method according to claim 5,
wherein when it is specified that only the person is the task assignee in a work area with the emergency storage bins arranged, in the work area selection processing, when it is determined that the emergency storage bins are arranged in a plurality of work areas and it is determined that a number arranged of the emergency storage bins is same between the work areas, the emergency order is allocated to a work area having a smallest remaining workload.

8. The order allocation method according to claim 5,
wherein when it is specified that only the person is the task assignee in a work area with the emergency storage bins arranged, in the work area selection processing, when it is determined that the emergency storage bins are arranged in a plurality of work areas and it is determined that the number arranged of the emergency storage bins is not same between the work areas, the emergency order is allocated to a work area with the largest number of the emergency storage bins arranged.

9. The order allocation method according to claim 5,
wherein when it is specified that only the robot is or both the person and the robot are the task assignee(s) in a work area with the emergency storage bins arranged, in the work area selection processing, when it is determined that tact time related to the emergency order is shorter in the robot than in the person based on the specification information, the emergency order is allocated to a work area for the robot with highest specification.

10. The order allocation method according to claim 5,
wherein when it is specified that only the robot is the task assignee or both the person and the robot are the task assignees in a work area with the emergency storage bins arranged, in the work area selection processing, when it is determined that tact time related to the emergency order is longer in the robot than in the person based on the specification information, the emergency order is allocated to a work area for smallest remaining workload and for the person.

11. The order allocation method according to claim 5,
wherein when it is specified that only the robot is the task assignee in a work area with the emergency storage bins arranged, in the work area selection processing, when it is determined that a number of uses of the emergency storage bins related to the emergency order is plural and it is determined that the specification of the robot is insufficient with respect to the number of uses of the emergency storage bins related to the emergency order, the emergency order is allocated to a work area with smallest remaining workload and for the person.

12. The order allocation method according to claim 1, further comprising:
a second conveyance step of acquiring a work completion notification related to the emergency order from a work area with the emergency order allocated, then determining a work progress related to a storage bin moved in response to the emergency order, conveying the moved storage bin to an original work area when the work related to the storage bin is in the middle of being performed, and conveying a storage bin related to a next order to the original work area when the work related to the storage bin is completed.

13. An information processing device for allocating an order related to picking work acquired from an external system to each work area for a person or a robot, the information processing device comprising:
a communication unit that acquires an emergency order from the external system; and
a controller that allocates the emergency order to at least one of the work areas based on work information on the order already allocated to each of the work areas, emergency storage bin information on an emergency storage bin that is a storage bin of an article related to the emergency order, and specification information on a specification of the robot.
